(19) United States
(12) Patent Application Publication
(10) Pub. No.: US 2026/0222759 A1
(43) Pub. Date: Jul. 30, 2026

(54) GENERATING A HEAD-RELATED FILTER MODEL BASED ON WEIGHTED TRAINING DATA

(71) Applicant: Telefonaktiebolaget LM Ericsson (publ), Stockholm (SE)

(72) Inventors: Erlendur KARLSSON, Uppsala (SE); Tomas JANSSON TOFTGÅRD, Uppsala (SE)

(73) Assignee: Telefonaktiebolaget LM Ericsson (publ), Stockholm (SE)

(21) Appl. No.: 19/137,711

(22) PCT Filed: Dec. 8, 2023
(86) PCT No.: PCT/EP2023/084945

§ 371 Date: Jun. 11, 2025

Related U.S. Application Data
(60) Provisional application No. 63/387,372, filed on Dec. 14, 2022.

(51) Int. Cl. H04S 7/00

(52) U.S. Cl. CPC H04S 7/304; H04S 2420/01

(57) ABSTRACT

There is provided a method for generating a head-related (HR) filter model for a set of HR filters. The method comprises obtaining HR filter data that indicates a plurality of sample points associated with a plurality of HR filters, wherein the plurality of sample points includes a first sample point. The method further comprises calculating a first weight value for the first sample point, wherein the first weight value varies based on a density of sample points within an area encompassing the first sample point. The method further comprises generating the HR filter model based on the calculated first weight value. (FIG. 11)

### TECHNICAL FIELD

This disclosure relates to generating a head-related (HR) filter model based on weighted training data.

### BACKGROUND

The human auditory system is equipped with two ears that capture the sound waves propagating towards a listener. FIG. 4 illustrates a sound wave propagating towards a listener from a direction of arrival (DoA) specified by a pair of elevation and azimuth angles in the spherical coordinate system. On the propagation path towards the listener each sound wave interacts with the listener's upper torso, head, outer ears, and the surrounding matter before reaching our left and right ear drums. This interaction results in temporal and spectral changes of the waveforms reaching the left and right eardrums, some of which are DoA dependent. The human auditory system has learned to interpret these changes to infer various spatial characteristics of the sound wave itself as well as the acoustic environment in which the listener finds himself/herself.

This capability is called spatial hearing, which concerns how spatial cues are evaluated embedded in the binaural signal, i.e., the sound signals in the right and the left ear canals, to infer the location of an auditory event elicited by a sound event e.g., a physical sound source and acoustic characteristics caused by the physical environment e.g., small room, tiled bathroom, auditorium, cave, etc. This human capability, spatial hearing, can in turn be exploited to create a spatial audio scene by reintroducing the spatial cues in the binaural signal that would lead to a spatial perception of a sound.

The main spatial cues include 1) angular-related cues: binaural cues, i.e., the interaural level difference (ILD) and the interaural time difference (ITD), and monaural (or spectral) cues; 2) distance-related cues: intensity and direct-to-reverberant (D/R) energy ratio. A mathematical representation of the short time DoA dependent temporal and spectral changes (1-5 msec) of the waveform are the so-called HR filters. The frequency domain (FD) representations of those filters are the so-called head-related transfer functions (HRTFs), and the time domain (TD) representations are the head-related impulse responses (HRIRs). FIGS. 19A-E illustrate an example of HR filters capturing ITD and spectral cues of a sound wave propagating towards a listener. The four plots illustrate the time domain and the frequency domain responses of a pair of HR filters obtained at an elevation of 0 degrees and an azimuth of 40 degrees (The data is from CIPIC database: subject-ID 28. The database is publicly available and can be access from the link https://www.ece.ucdavis.edu/cipic/spatial-sound/hrtf-data/.).

HR filters are often estimated from acoustic measurements as the impulse response of a linear dynamic system that transforms the original sound signal (input signal) into the left and right ear signals (output signals) that can be measured inside the ear channels of a listening subject at a predefined set of elevation and azimuth angles on a spherical surface of constant radius from a listening subject for e.g., an artificial head, a manikin or human subjects.

The estimated either by measurement or by numerical simulation HR filters are often provided as Finite Impulse Response (FIR) filters and can be used directly in that format. To achieve an efficient binaural rendering, a pair of HRTFs may be converted to Interaural Transfer Function (ITF) or modified ITF to prevent abrupt spectral peaks. Alternatively, HRTFs may be described by a parametric representation. Such parameterized HRTFs are easy to be integrated with parametric multichannel audio coders, e.g., Moving Picture Experts Group (MPEG) surround and Spatial Audio Object Coding (SAOC).

Rendering a spatial audio signal to provide a convincing spatial perception of a sound at an arbitrary location in space requires a pair of HR filters at the corresponding location, and thus, a set of HR filters at finely sampled locations on a two-dimensional (2D) sphere may be provided. Note that, in this disclosure, a 2D sphere means the surface or the boundary of a virtual three-dimensional (3D) ball that may surround a listener. Minimum audible angle (MAA) characterizes the sensitivity of the human auditory system to an angular displacement of a sound event.

Regarding localization in azimuth, MAA has been observed to be the smallest in the front and back (about 1 degree) of the listener, and much greater for lateral sound sources (about 10 degrees) for a broadband noise burst. MAA in the median plane increases with elevation. As small as 4 degrees of MAA on average in elevation has been observed with broadband noise bursts. There are some publicly available HR filter databases, densely sampled in space, such as SADIE database, CIPIC database. However, none of them completely fulfills the MAA requirement, particularly with respect to sampling in elevation. Even though SADIE datasets of the artificial head Neumann KU100 and the KEMAR mannequin contain more than 8000 measurements, its sampling resolution in elevation between-15 degrees to 15 degrees is 15 degrees while 4 degrees is required according to the MAA studies. Inevitably, an angular interpolation of HR filters is needed so that a sound source can be rendered at locations where no actual filters have been measured.

In order to obtain HR filters for the locations where no actual filters were measured, an HR filter model, modeling HR filters, can be used. This HR filter model may be a function of an elevation angle and an azimuth angle and may be configured to calculate an HR filter corresponding to a particular elevation angle and a particular azimuth angle. Methods of modelling HR filters, thereby generating an HR filter model are disclosed in PCT/EP2022/074787, WO 2022/223132, WO 2022/008549, WO 2021/254652, and WO 2021/074294.

### SUMMARY

Certain challenges presently exist. For example, it has been observed that the modeling accuracy of an HR filter model i.e., which indicates how well the HR filter model models a plurality of HR filters may not satisfy a desired accuracy level in those regions e.g., either regions of the 2D sphere or the regions of the elevation-azimuth plane having a relatively low (or lowest) density of HR filters. These regions typically correspond to spatial regions having the elevation angle below −60 degrees and spatial regions having the elevation angle above 60 degrees in the 2D sphere or the elevation-azimuth plane.

As a result of failing to satisfy the desired accuracy level, the subjective quality of a rendered audio source in those spatial regions which is rendered using the HR filter model is much lower as compared to other spatial regions where modelling accuracy of the HR filter is high.

One explanation for the poor modeling accuracy of the HR filter model in those regions is that those regions do not contribute as much to the total modeling error measure as compared to the regions with high sampling density since the number of sample points in those regions is much fewer than the number of sample points in the regions with high sampling density. Similarly, regions further away from the equator of the sphere of sample points (towards the poles) will contribute less to the total modeling error measure, even if the density on the sphere would be equal. Therefore, the regions with a low sampling density and/or being represented by a relatively small number of sample points are modeled with lesser accuracy.

Accordingly, in some embodiments of this disclosure, the modeling accuracy of an HR filter model may be improved while minimally increasing the modeling errors in other areas, by weighting sample points in the regions e.g., either the regions of the 2D sphere or the regions of the elevation-azimuth plane having a relatively low density of HR filters more than the sample points in the regions, which have a relatively high density of HR filters.

More specifically, in one aspect of some embodiments of this disclosure, there is provided a method for generating a head-related (HR) filter model for a set of HR filters. The method comprises obtaining HR filter data that indicates a plurality of sample points associated with a plurality of HR filters, wherein the plurality of sample points includes a first sample point. The method further comprises calculating a first weight value for the first sample point, wherein the first weight value varies based on a density of sample points within an area encompassing the first sample point. The method further comprises generating the HR filter model based on the calculated first weight value.

In another aspect, there is provided a computer program comprising instructions which when executed by processing circuitry cause the processing circuitry to perform the method of any one of the embodiments described above.

In another aspect, there is provided a carrier containing the computer program of the above embodiment, wherein the carrier is one of an electronic signal, an optical signal, a radio signal, and a computer readable storage medium.

In another aspect, there is provided an apparatus for generating a head-related, HR, filter model for a set of HR filters. The apparatus is configured to obtain HR filter data that indicates a plurality of sample points associated with a plurality of HR filters, wherein the plurality of sample points includes a first sample point. The apparatus is further configured to calculate a first weight value for the first sample point, wherein the first weight value varies based on a density of sample points within an area encompassing the first sample point. The apparatus is further configured to generate the HR filter model based on the calculated first weight value.

In another aspect, there is provided an apparatus comprising: a processing circuitry; and a memory, said memory containing instructions executable by said processing circuitry, whereby the apparatus is operative to perform the method of at least one of the embodiments described above.

Some embodiments of this disclosure provide more consistent modeling performance over a set of HR filters that are distributed unevenly, by improving the modeling accuracy in those regions with a relatively low density of HR filters while maintaining low modeling errors in other spatial regions.

### BRIEF DESCRIPTION OF THE DRAWINGS

The accompanying drawings, which are incorporated herein and form part of the specification, illustrate various embodiments.

FIG. 1 shows a system according to some embodiments.

FIGS. 2A, 2B, 3A, and 3B illustrate concept of an HR filter.

FIG. 4 shows a direction of arrival of an audio wave as observed from the listener, within a three-dimensional (3D) space.

FIG. 5 shows a set of HR filters located on a 2D sphere.

FIG. 6 shows a distribution of sample points associated with HR filters.

FIG. 7 shows a distribution of sample points associated with HR filters.

FIG. 8 shows a process according to some embodiments.

FIG. 9 shows a method of determining a boundary of a sample point area according to some embodiments.

FIG. 10 shows a method of determining a boundary of a sample point area according to some embodiments.

FIG. 11 shows an exemplary sample point area of a sample point.

FIG. 12 shows sample point area count-distribution of a complete set of elevation-azimuth sample points shown in FIG. 6.

FIG. 13 shows a cumulative sample point area count-distribution of a complete set of elevation-azimuth sample points shown in FIG. 6.

FIG. 14 shows an exemplary weight count-distribution.

FIG. 15 shows an exemplary cumulative weight count-distribution.

FIG. 16 shows a variation of weight values that depends on the sizes of sample point areas.

FIG. 17 shows a process according to some embodiments.

FIG. 18 shows an apparatus according to some embodiments.

FIGS. 19A-19E shows a sound wave propagating towards a listener, interacting with head and ears, and the resulting ITD.

### DETAILED DESCRIPTION

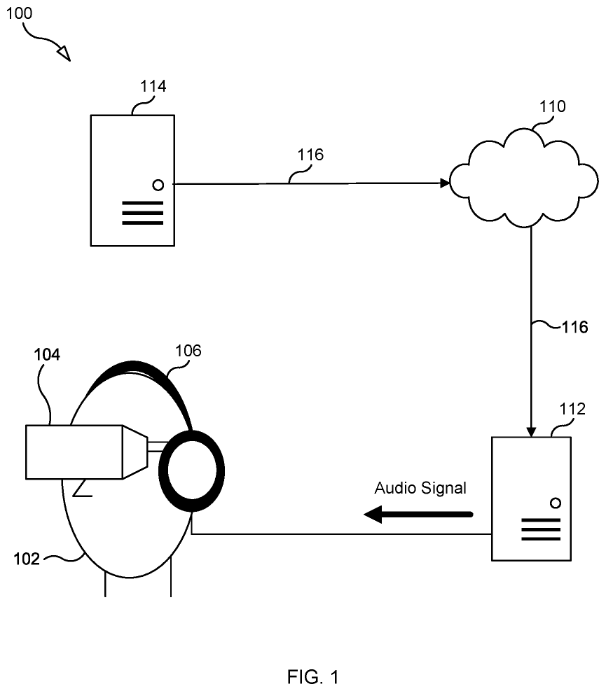

FIG. 1 shows an exemplary system 100 according to some embodiments. System 100 comprises a headphone 106, an audio rendering unit 112, and a server 114. Server 114 is configured to transmit audio data 116 to audio rendering unit 112 via network 110. Network 110 may be a wired network or a wireless network. Alternatively or additionally, network 110 may be a cloud via which audio data 116 is transmitted from server 114 to audio rendering unit 112. In this disclosure, audio data is defined as data used for, after rendering e.g., processing with HR filter(s), providing the listener with an audio experience as if the listener is in a three-dimensional (3D) space where audio source(s) are located. The audio data includes audio samples of source signals corresponding to audio source(s). In some embodiments, the audio data may additionally include HR filter information indicating HR filters.

After receiving audio data 116, audio rendering unit 112 may generate binaural audio signals and transmit the generated audio signals to headphone 106. Headphone 106 is configured to generate audio based on the audio signals, thereby providing the listener 102 with audio (also called spatial audio) experience. In some embodiments, instead of headphone 106, other audio generating devices such as an array of speakers may be used. The number of the speakers in the array can be any number larger than two.

In some embodiments, system 100 may optionally comprise an extended reality (XR) such as virtual reality, mixed reality, or augmented reality display headset 104. XR display headset 104 may be configured to generate different views of a virtual reality (VR) environment based on the head orientation of the listener 102.

XR display headset 104 may be communicatively coupled to headphone 106. For example, the XR display headset 104 may detect the head orientation of the listener 102, and based on the detected head orientation of the listener 102, the XR display headset 104 may display a different view of the VR environment and may trigger audio rendering unit 112 to generate different audio signals corresponding to different views such that the listener 102 can hear different audio based on the head orientation of the listener 102.

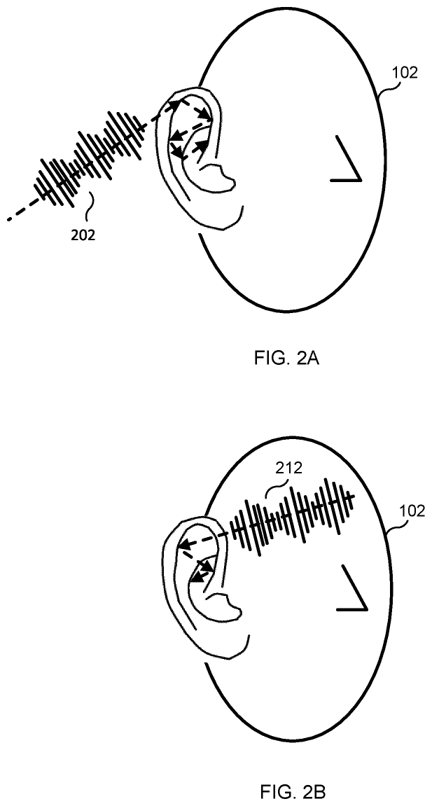

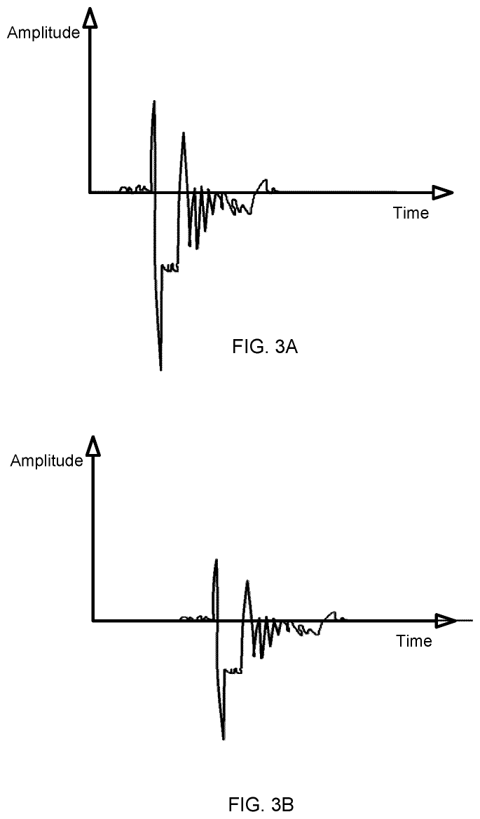

FIGS. 2A, 2B, 3A, and 3B illustrate basic concept of HR filtering.

FIG. 2A shows an audio wave 202 propagating in a first direction and reaching the right ear of the listener 102, and FIG. 2B shows an audio wave 212 propagating in a second direction (that is different from the first direction) and reaching the right ear of the listener 102. As shown in FIGS. 2A and 2B, depending on the direction of arrival (DoA) of the audio waves (with respect to the center of the listener 102's head), the audio waves are diffracted and/or reflected in different ways (see the paths formed by the dotted arrows in FIGS. 2A and 2B). For simple explanation, only the reflections are shown in FIGS. 2A and 2B.

HR filters are used for generating audio effects in which these different diffractions and reflections caused by different DoAs are factored. In other words, depending on the DoA of an audio wave, the audio wave goes through different temporal and spectral changes before being sensed by the listener 102, and a mathematical representation of such temporal and spectral changes is called an HR filter. Note that the reflection paths shown in FIGS. 2A and 2B are provided for illustration purpose only and may be different from actual reflection paths in a real world environment.

FIG. 3A shows an exemplary time domain response of an HR filter for audio wave 202 and FIG. 3B shows an exemplary time domain response of an HR filter for audio wave 212. As shown in the figures, because of the different temporal and spectral changes the audio waves go through, the waveforms, including the amplitude and the time of arrival (TOA) or onset delay,) are different for audio waves 202 and 212. Note that the responses shown in FIGS. 3A and 3B are provided just to show few aspects of the impact of the HR filters, and thus may be different from the real responses.

As discussed above, the temporal and spectral changes of an audio wave a.k.a., “sound wave” caused by the HR filtering vary depending on a direction of arrival (DoA) of the audio wave as observed from the listener.

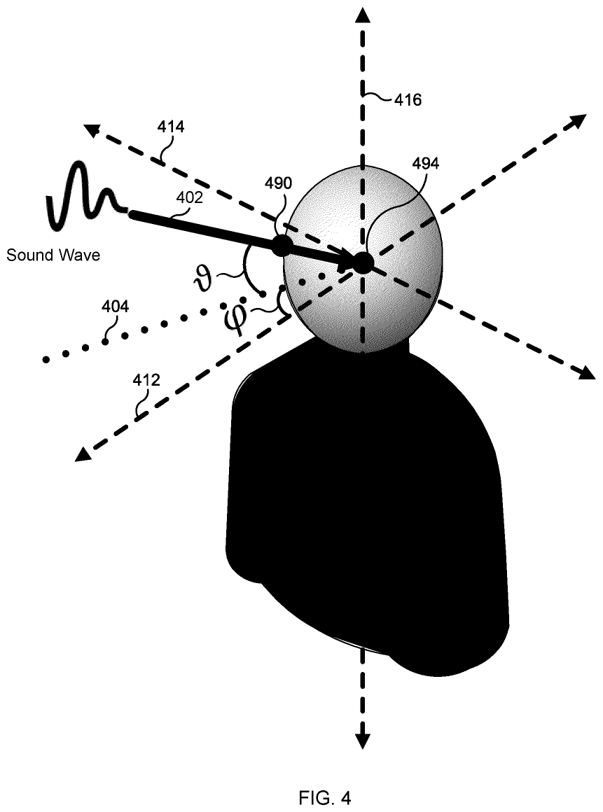

In FIG. 4, a direction of arrival (DoA) vector 402 indicates the propagation direction of an audio wave within a 3D space defined by three axes 412, 414, and 416, where axes 412 is the front axes of the listener. DoA vector 402 may be defined using two angles—azimuth angle (φ) and elevation angle (ϑ). The azimuth angle (φ) is an angle between an axis 412 e.g., an x-axis and a projection vector 404 corresponding to a projection of DoA vector 402 onto a plane formed by axis 412 and an axis 414. The elevation angle (ϑ) is an angle between DoA vector 402 and projection vector 404.

Since the temporal and spectral changes of an audio wave may vary depending on the azimuth angle (φ or φ) and the elevation angle (ϑ or θ), in some embodiments, different HR filters (which represent such temporal and spectral changes) are provided for different combinations of the azimuth angle (φ) and the elevation angle (ϑ).

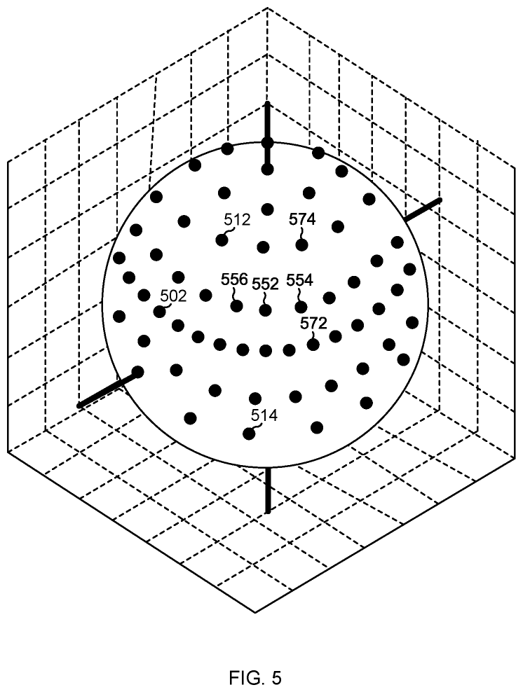

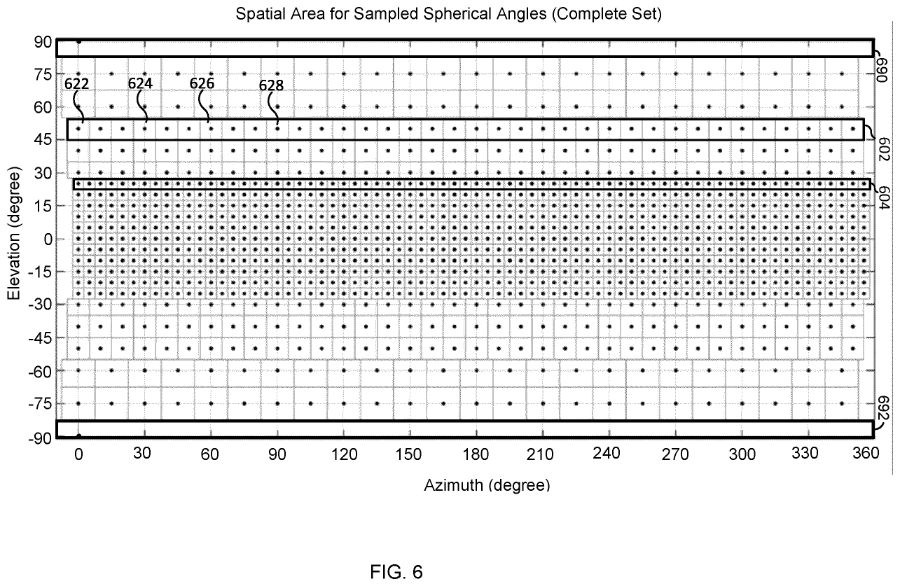

FIG. 5 shows exemplary locations a.k.a., sample points 502 of a set of HR filters a.k.a., an HR filter set on a two-dimensional (2D) sphere surrounding the listener 102. As shown in FIG. 4, each sample point (e.g., 490) may be defined by a pair of an azimuth angle (φ) and an elevation angle (ϑ). The azimuth angle is an angle between axis 412 and a projection (e.g., 404) of a line (e.g., 402) formed by a sample point (e.g., 490) and a center (e.g., 494) of the 2D sphere onto the plane formed by axis 412 and axis 414. The elevation angle is an angle between the line (e.g., 402) and the projection (e.g., 404). In some embodiments, the center of the 2D sphere may correspond to the center of the head of the listener 102. Because each sample point may be defined by a pair of an elevation angle and an azimuth angle on the 2D sphere, so as shown in FIG. 6, each sample point may also be defined in a 2D plane that is defined by an elevation angle and an azimuth angle.

The HR filter set may be used for generating audio depending on the head orientation of the listener 102. For example, an HR filter at a sample point 512 may be used for generating audio corresponding to a first combination (φ₁, θ₁) of an azimuth angle and an elevation angle, which corresponds to the listener 102's first DoA while an HR filter at a sample point 514 included in the HR filter set may be used for generating audio corresponding to a second combination (φ₂, θ₂) of an azimuth angle and an elevation angle, which corresponds to the listener 102's second DoA.

As discussed above, HR filters are often estimated from acoustic measurements as the impulse response of a linear dynamic system that transforms the original sound signal (input signal) into the left and right ear signals (output signals) that can be measured inside the ear channels of a listening subject at a predefined set of elevation and azimuth angles. However, as shown in FIG. 5, the density of sample points in one region of the 2D sphere may be different from the density of sample points in another region of the 2D sphere.

Alternatively or additionally, as shown in FIG. 6, the density of sample points in one region of the elevation-azimuth plane may be different from the density of sample points in another region of the elevation-azimuth plane. Note that, in this disclosure, the density of sample points and the density of HR filters are used interchangeably because each sample point corresponds to the location of each HR filter.

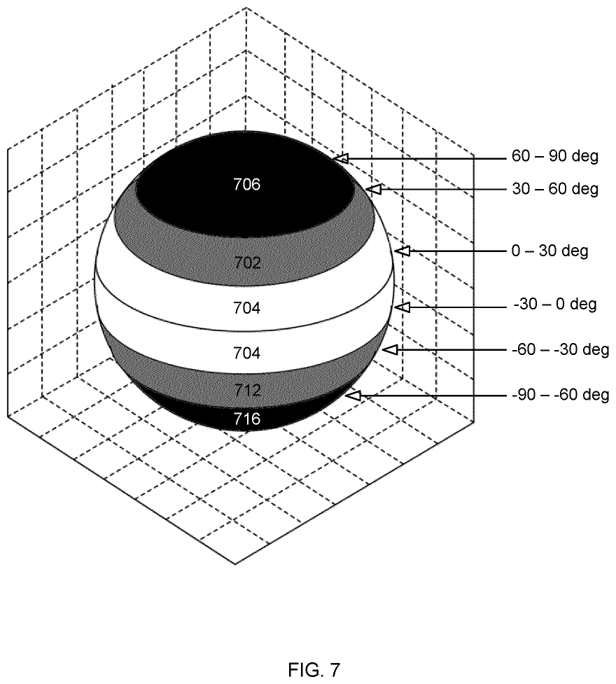

FIG. 6 shows a detailed view of a distribution of sample points where HR filters are located across the elevation-azimuth plane. In this disclosure, the elevation-azimuth plane means a plane corresponding to the surface of the 2D sphere when the surface of the sphere is expanded on a flat surface. As shown in FIG. 6, the density of sample points in each of a region between 30° and 60° elevation angles (i.e., region 702 in FIG. 7) and a region between −30° and −60° elevation angles (i.e., region 712 in FIG. 7) is lower than the density of sample points in a region between −30° and 30° elevation angles (i.e., region 704 in FIG. 7).

Similarly, the density of sample points in each of a region between 60° and 90° elevation angles (i.e., region 706 in FIG. 7) and a region between −60° and −90° elevation angles (i.e., region 716 in FIG. 7) is lower than the density of sample points in a region between −30° and 30° elevation angles (i.e., region 704 in FIG. 7).

As discussed above, initially, HR filters are obtained by performing acoustic measurements. Thus, as shown in the table provided below, each measured HR filter may correspond to an acoustic measurement at a different location (φₙ, θₙ).

| | |
|---|---|
| Measured HR Filter at (φ₁, θ₁) | Acoustic Measurement at (φ₁, θ₁) |
| Measured HR Filter at (φ₂, θ₂) | Acoustic Measurement at (φ₂, θ₂) |
| . . . | . . . |
| Measured HR Filter at (φ_{N}, θ_{N}) | Acoustic Measurement at (φ_{N}, θ_{N}) |

where N is the total number of the measured HR filters.

These measured HR filters may be modeled by determining an HR filter model having a set of model parameters. The HR filter model is for generating a modeled HR filter at any location (φ, θ) based on a value of φ and a value of θ.

The HR filter model may be determined such that differences between the measured HR filters and the modeled HR filters are minimized given the certain model structure. In other words, during modelling of the measured HR filters, a set of model parameters resulting in the minimum differences between the measured HR filters and the modeled HR filters may be determined.

| | | |
|---|---|---|
| Measured HR Filter at (φ₁, θ₁) | Modeled HR Filter at (φ₁, θ₁) | Difference at (φ₁, θ₁) |
| Measured HR Filter at (φ₂, θ₂) | Modeled HR Filter at (φ₂, θ₂) | Difference at (φ₂, θ₂) |
| . . . | . . . | . . . |
| Measured HR Filter at (φ_{N}, θ_{N}) | Modeled HR Filter at (φ_{N}, θ_{N}) | Difference at (φ_{N}, θ_{N}) |

However, because of the above discussed imbalance among the densities of the sample points in different regions i.e., either regions of the 2D sphere shown in FIG. 5 or regions of the elevation-azimuth angle plane shown in FIG. 6, the determined HR filter model i.e., the determined set of model parameters may only be optimal for generating HR filters in the regions where the density of the sample points is high but may not be optimal for generating HR filters in the region where the density of the sample points is low.

More specifically, because of the imbalance, the modelling process may be geared towards finding a set of model parameters for generating HR filters that closely resemble the HR filters in the regions where the density of the sample points is high. As a result, the generated HR filter model may not be optimal for generating HR filters i.e., HR filters similar to the measured HR filters closely resembling measured HR filters in the regions where the density of the HR filters is low.

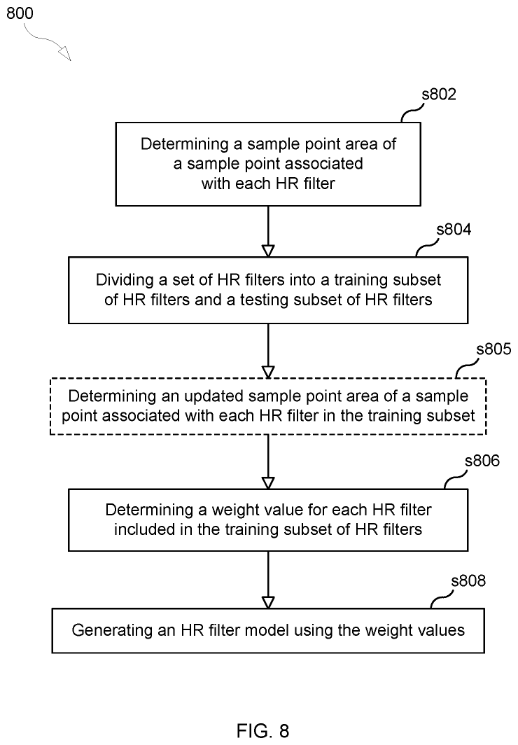

In order to improve the modeling accuracy of the HR filter model in those regions with low sample point densities, process 800 shown in FIG. 8 may be performed. Process 800 may begin with step s802. Step s802 comprises determining a spatial area a.k.a., a sample point area of a sample point associated with each HR filter included in a set of HR filter set that contains a plurality of measured HR filters. One way of determining a sample point area herein after, “SP area” of a sample point is by dividing the area located between two adjacent sample points equally.

The sample point area may be determined for the samples represented on a sphere or represented in the elevation-azimuth angle plane. One advantage of representing the samples in the elevation-azimuth angle plane is that the samples further from the equator of the sphere i.e., closer to the poles, will be spread out and thereby be represented by a larger SP area than samples closer to the equator of the sphere i.e., further from the poles. This means that sample points in both regions with low sampling density and in regions being represented by a relatively small number of sample points will correspond to a larger SP area than sample points in the regions with high sampling density and/or being represented by a relatively high number of samples. In accordance with some embodiments herein, this allows weighting sample points in the regions with low sampling density more than the sample points in the regions with high sampling density.

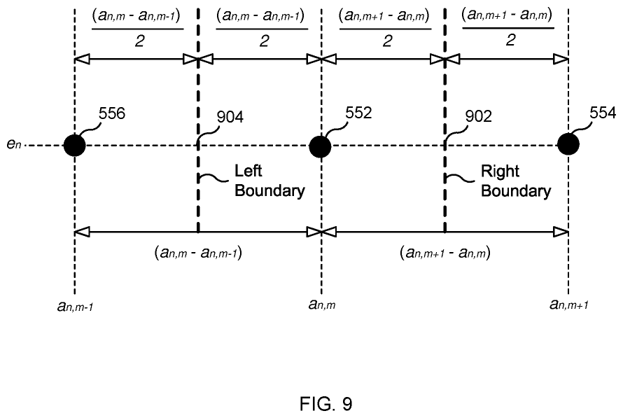

FIG. 9 illustrates a method of dividing the area between two adjacent sample points having the same elevation angle (eₙ) but different azimuth angles (a_{n,m-1}, a_{n,m}, and a_{n,m+1}).

As shown in FIGS. 5 and 9, a sample point 552 and a sample point 554 are located at the same elevation angle but different azimuth angles. In this case, a right boundary of an SP area of sample point 552 may be determined based on a distance for e.g., defined in elevation or azimuth angles, between sample point 552 and sample point 554. More specifically, the right boundary of the SP area of sample point 552 may be determined such that the right boundary aligns with a middle point 902 between sample point 552 and sample point 554. Similarly, sample point 552 and a sample point 556 are located at the same elevation angle but different azimuth angles. Here, a left boundary of an SP area of sample point 552 may be determined based on a distance between sample point 552 and sample point 556. More specifically, the left boundary of the SP area of sample point 552 may be determined such that the left boundary aligns with a middle point 904 between sample point 552 and sample point 556.

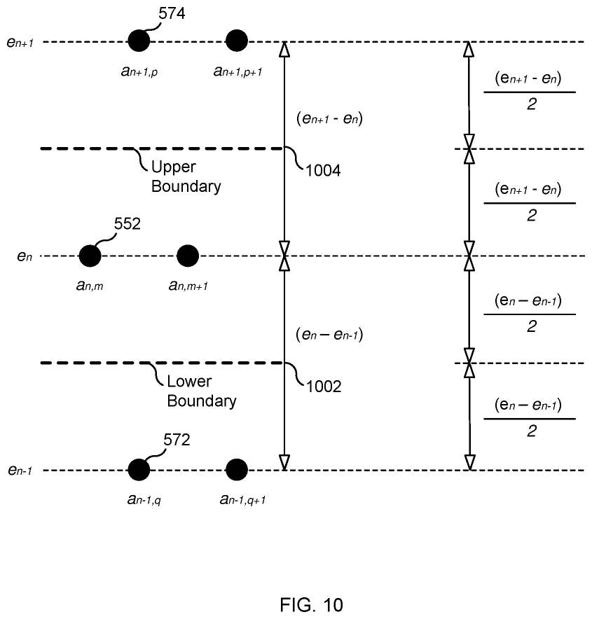

FIG. 10 illustrates a method of dividing the area between two adjacent sample points having different elevation angles (eₙ₋₁, eₙ, eₙ₊₁). As shown in FIGS. 5 and 10, sample point 552 and a sample point 574 are located at different elevation angles and different azimuth angles. In this case, an upper boundary of sample point 552 may be determined based on a difference between the elevation angle of sample point 552 and the elevation angle of sample point 574. More specifically, the upper boundary of sample point 552 may be determined such that the upper boundary aligns with a middle point 1004 between sample point 552 and sample point 574. Similarly, sample point 552 and a sample point 572 are located at different elevation angles and different azimuth angles. In this, a lower boundary of sample point 552 may be determined based on a difference between the elevation angle of sample point 552 and the elevation angle of sample point 572. More specifically, the lower boundary of sample point 552 may be determined such that the lower boundary aligns with a middle point 1002 between sample point 552 and sample point 572.

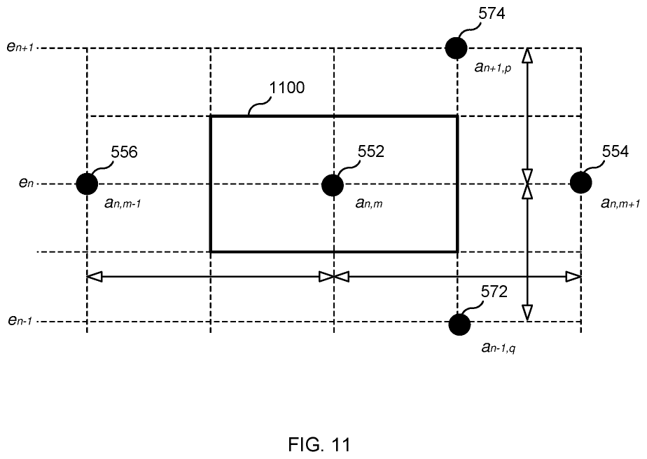

FIG. 11 shows SP area 1100 of sample point 552, which is obtained from the methods illustrated in FIGS. 9 and 10. As explained above, the left and right boundaries of SP area 1100 is determined using the method illustrated in FIG. 9 and the upper and lower boundaries of SP area 1100 is determined using the method illustrated in FIG. 10.

Note that, even though FIGS. 9-11 show that the shape of the SP area of sample point 552 is a rectangle, the shape of the SP area may be any polygon. Also, in other embodiments, the shape of the SP area may be a circle or an ellipse. In any of those embodiments, the size of the SP area may be determined based on any one or more of the distances between sample point 552 and any one or more of sample points adjacent to sample point 552 (e.g., sample points 554, 556, 572, and/or 574).

The scenario illustrated in FIG. 11 is a general one. Thus, further clarification is needed in some specific scenarios. For example, as the azimuth angles are circular, the minimum elevation angle is −90 degrees

$$( - \frac{π}{2} radians )$$

and the maximum elevation angle is 90 degrees

$$( \frac{π}{2} radians ) .$$

The circularity of the azimuth angles means that an azimuth angle of a degrees equals to a+k*360 for any positive or negative integer value k, where the corresponding equality for a in radians is a+k*2π.

In one example, the azimuth angle of the sample point 556 in FIG. 11—a_{n,m-1}—could be a negative azimuth value, which may be mapped to a positive azimuth value of 360+a_{n,m-1}. An example of this is illustrated in FIG. 6. When the sample point having the elevation angle of −60 degree and the azimuth angle of 0 degree is the sample point 552 in FIG. 11, the sample point having the elevation angle of −60 degree and the azimuth angle of 345 degrees may correspond to the sample point 556.

In another example, the azimuth angle of the sample point 554 in FIG. 11—a_{n,m+1}—could be a value greater than or equal to 360 degree, which may be mapped to a positive azimuth value in the range [0, 360) of a_{n,m+1}−360. An example of this is illustrated in FIG. 6. When the sample point having the elevation angle of −60 degree and the azimuth angle of 345 degree is sample point 552 in FIG. 11, then the sample point having the elevation angle of −60 degree and the azimuth angle of 0 degree may correspond to the sample point 554.

In some scenarios, the sample point 552 in FIG. 11 may be the only sample point at the elevation angle eₙ. For example, the sample point 552 may be at θ=−70, φ=0. In this example, the azimuth-span (corresponding to the width of the SP area 1100) of the sample point 552 may set to be 360 degrees or 2×π radians, and the elevation-span (corresponding to the height of the SP area 1100) of the sample point 552 may be determined as described above with respect to FIG. 10 (i.e., the elevation-span of the sample point

$$552 = \frac{( {e}_{n + 1} - {e}_{n} )}{2} + \frac{( {e}_{n} - {e}_{n - 1} )}{2} ) .$$

In FIG. 10, the sample point 552 has adjacent sample points in elevation angles of two opposite directions. More specifically, the sample point 574 is the sample point that is adjacent to the sample point 552 in the positive direction of the elevation angle (meaning that eₙ₊₁>eₙ) and the sample point 572 is the sample point that is adjacent to the sample point 552 in the negative direction of the elevation angle (meaning that eₙ₋₁<eₙ).

However, in some scenarios, the sample point 552 may have an adjacent sample point in only one direction of the elevation angle when the sample point 552 is located in a certain area (e.g., area 690 or 692) within the elevation-azimuth plane.

For example, in case the sample point 552 is at θ=−90, φ=0, there is no sample point that is adjacent to the sample point 552 in the negative direction of the elevation angle because no sample point exists at θ<−90. In such case, the elevation-span (corresponding to the height of the SP area 1100) of the sample point 552 may be determined as ½ of the difference between the elevation angle of the sample point 552 and the elevation angle of the sample point adjacent to the sample point 552 in the one direction of the elevation angle (e.g., the elevation-span of the sample point

$$552 = \frac{( {e}_{n + 1} - {e}_{n} )}{2} ,$$

corresponding to the upper boundary 1004 shown in FIG. 10, since sample points at the elevation angle of the sample point 572 would not exist in case the sample point 552 is at θ=−90).

In another example, in case the sample point 552 is at θ=90, φ=0, there is no sample point that is adjacent to the sample point 552 in the positive direction of the elevation angle because no sample point exists at θ>90. In such case, the elevation-span (corresponding to the height of the SP area 1100) of the sample point 552 may be determined as ½ of the difference between the elevation angle of the sample point 552 and the elevation angle of the sample point adjacent to the sample point 552 in the one direction of the elevation angle (e.g., the elevation-span of the sample point

$$552 = \frac{( {e}_{n} - {e}_{n - 1} )}{2} ,$$

corresponding to the lower boundary 1002 shown in FIG. 10, since sample points at the elevation angle of the sample point 574 would not exist in case the sample point 552 is at θ=90).

FIG. 6 shows examples of sample point areas of a plurality of sample points.

Referring back to FIG. 8, after performing step s802, process 800 may proceed to step s804. Step s804 comprises dividing a set of HR filters into a subset of HR filters for training an HR filter model a.k.a., a “training subset of HR filters and a subset of HR filters for testing the generated HR filter model (a.k.a., a “testing subset of HR filters”. In other words, the training subset of HR filters is for generating an HR filter model while the testing subset of HR filters is for testing i.e., verifying/validating, the generated HR filter model at sample points that were not used in the training the HR filter model.

As discussed above, since the modelling accuracy of the HR filter model is low i.e., does not reach a desired or acceptable level, in the regions with low sampling point density, according to some embodiments, all HR filters located at the sample points in those regions are included in the training subset of HR filters, and thus are used in generating an HR filter model. In addition to the HR filters located at sample points in those regions, at least some HR filters located at sample points in those regions with high sampling point density may also be included in the training subset of HR filters, and thus are used in generating the HR filter model.

According to some embodiments, the set of HR filters may be split into a training subset of HR filters and a testing subset of HR filters based on a cumulative count distribution of the sample point areas of all available HR filters.

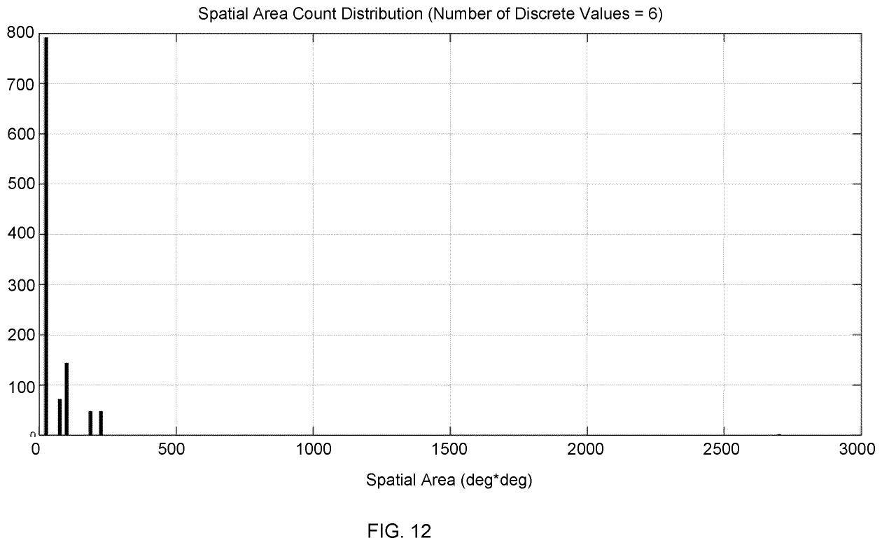

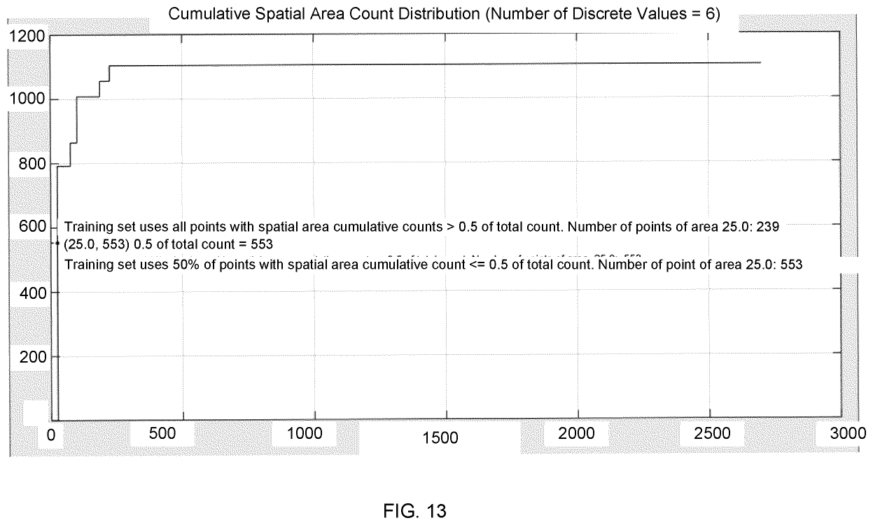

FIG. 12 illustrates the SP area count-distribution of the example set of elevation-azimuth sample points illustrated in FIG. 6, and FIG. 13 illustrates the cumulative SP area count-distribution of the example set of elevation-azimuth sample points illustrated in FIG. 6 including a training set specification based on the cumulative distribution.

Before selecting the training subset of HR filters, after obtaining the SP area of each sample point in step s802, the HR filters may be arranged based on the size of the SP areas. For example, the HR filters may be arranged in the order of decreasing the spatial area. The table provided below illustrates an order of arranging the HR filters according to the size of the SP areas. In the table below, the size of the SP area of each HR filter is indicated by the size of a table cell corresponding to each HR filter.

| | | | | | | | | |
|---|---|---|---|---|---|---|---|---|
| HR1 | HR2 | HR3 | HR4 | HR5 | HR6 | HR7 | HR8 | . . . |

More specifically, in the table above, the size of the SP area of HR filter 1>the size of the SP area of HR filter 2>the size of the SP area of HR filter 3> . . . . In some cases, the SP areas of two or more HR filters may have the same size. For example, in the table provided above, the size of the SP area of HR filter 5 is same as the size of the SP area of HR filter 6 and the size of the SP area of HR filter 7. In such case, the HR filters having the SP areas of the same size can be arranged in any order. Thus, the size of SP area of HR filter 1>the size of SP area of HR filter 2>the size of SP area of HR filter 3>the size of SP area of HR filter 4>the size of SP area of HR filter 5=the size of SP area of HR filter 6=the size of SP area of HR filter 7>the size of SP area of HR filter 8. In a summary, the HR filters may be arranged such that the size of SP area 1≥the size of SP area 2>the size of SP area 3≥the size of SP area 4 . . . .

One way of selecting a training subset of HR filters in step s802 is to first select first m number of HR filters or first pₘ % of the total number of HR filters, in the ordered list and then select n number of the remaining HR filters (or pₙ % of the remaining HR filters, following the first m number of HR filters in the ordered list, and include the selected HR filters in the training subset of HR filters. In one example, m is equal to ½ of the total number of sample points (50%) and n corresponds to 50% of the remaining HR filters. n and m can be any positive value.

Another way of selecting a training subset of HR filters in step s802 is selecting all HR filters located at sample points each having an SP area larger than a threshold ψ and then selecting q % of HR filters located at sample points each having an SP area equal to or smaller than the threshold ψ, where the q % may be randomly or pseudo-randomly selected.

For example, assume that each HR filter included in a half of given HR filters i.e., a first group of HR filters, has an SP area that is larger than a threshold SP area size and each HR filter included in the remaining half of the given HR filters i.e., a second group of HR filters, has an SP area that is smaller than or equal to the threshold SP area size. In such example, the first group of HR filters and any HR filter randomly selected from the second group of HR filters are selected and included in the training subset of HR filters. The number/percentage of HR filters that are to be selected randomly can be configured to be any number. In one example, 50% of HR filters located at the sample points having an SP area equal or smaller than the threshold ψ are selected to be included in the training subset of HR filters.

In some embodiments, instead of randomly selecting the pₙ % or 9% of HR filters, a different method may be used for selecting the pₙ % or q % of HR filters. For example, the selected pₙ % or q % of HR filters may correspond to the HR filters that are evenly distributed over azimuth angle. More specifically, from among the HR filters each having an SP area that is smaller than or equal to the threshold SP area size, one or more groups (e.g., 602 and/or 604) of HR filters are identified where HR filters in each group have the same size of the SP area. Then from within each group, pₙ % or q % of HR filters (e.g., 622, 624, 626, 628) may be selected such that the selected HR filters are evenly distributed over the azimuth angle.

Once the training subset of HR filters is selected, the rest of the HR filters included in the set of HR filters may be used as the testing subset of HR filters.

After performing step s804, process 800 may proceed to step s806. Step s806 comprises determining a weight value for each HR filter included in the training subset of HR filters. In some embodiments, the weight value of a sample point is determined based on the size of an SP area of the sample point, which is determined in step s802. In other embodiments, however, the weight value of a sample point is determined based on the size of an updated SP area of the sample point, determined in step s805 which is explained in detail below.

More specifically, in some embodiments, a weight vector w=(w₁, . . . w_{N}_{_{T}}) containing the weight values of N_{T} HR filters included in the training subset of HR filters may be obtained as a function of the SP area vector a=(a₁, . . . a_{N}_{_{T}}), which contains the sizes of the SP areas of N_{T} HR filters. The weight vector may be a function of the SP area vector, meaning that w=f(a), where HR filters with larger SP areas have higher weights as compared to HR filters with smaller SP areas.

In one example, the weight vector may be determined as follows:

$$w = ( \begin{matrix}{w}_{1} \\ ⋮ \\ {w}_{N}\end{matrix} ) = ( \begin{matrix}\sqrt{{N}_{T} \frac{{a}_{1}}{{a}_{T}}} \\ ⋮ \\ \sqrt{{N}_{T} \frac{{a}_{N}}{{a}_{T}}}\end{matrix} )$$

where wₙ is a weight value of n-th HR filter included in the training subset of HR filters, an is the size of the SP area of the n-th HR filter, a_{T} is the total area of the elevation-azimuth plane or of the part of the elevation-azimuth plane that is being modeled e.g., a sum of the SP areas of HR filters shown in FIG. 6, and N_{T} is a total number of HR filters included in the training subset of HR filters.

In another example, the weight vector may be determined as follows:

$$w = ( \begin{matrix}{w}_{1} \\ ⋮ \\ {w}_{N}\end{matrix} ) = ( \begin{matrix}\sqrt{\frac{{a}_{1}}{{a}_{T}}} \\ ⋮ \\ \sqrt{\frac{{a}_{N}}{{a}_{T}}}\end{matrix} )$$

In further example, the weight vector may be determined as follows:

$$w = ( \begin{matrix}{w}_{1} \\ ⋮ \\ {w}_{N}\end{matrix} ) = ( \begin{matrix}{N}_{T} \frac{{a}_{1}}{{a}_{T}} \\ ⋮ \\ {N}_{T} \frac{{a}_{N}}{{a}_{T}}\end{matrix} )$$

In further example, the weight vector may be determined as follows:

$$w = ( \begin{matrix}{w}_{1} \\ ⋮ \\ {w}_{N}\end{matrix} ) = ( \begin{matrix}\frac{{a}_{1}}{{a}_{T}} \\ ⋮ \\ \frac{{a}_{N}}{{a}_{T}}\end{matrix} )$$

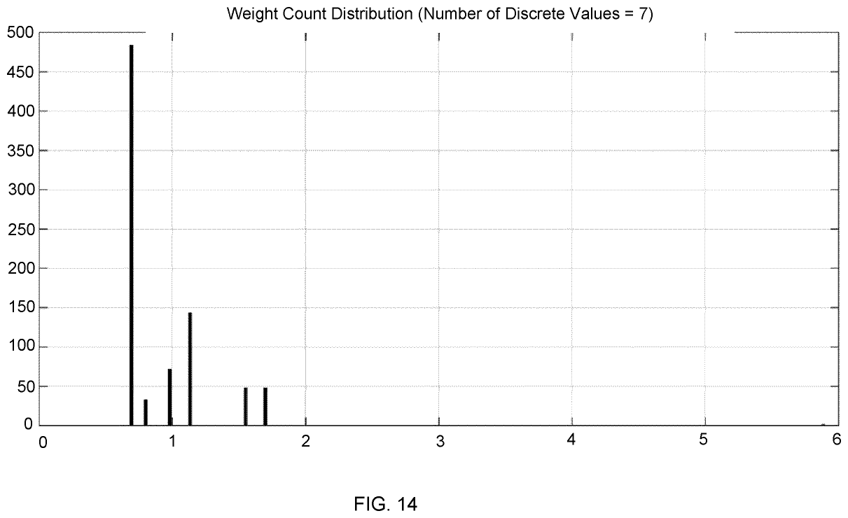

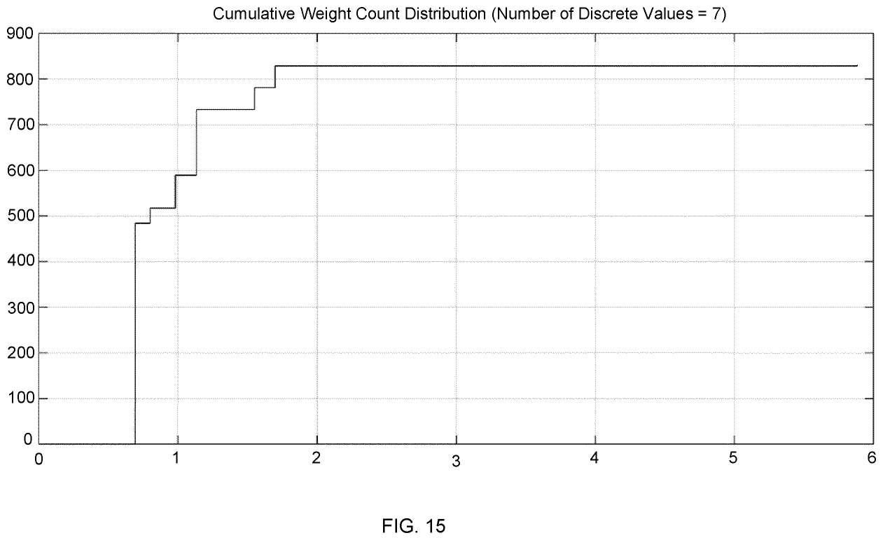

FIG. 14 shows a weight-count distribution according to some embodiments, and FIG. 15 shows a cumulative weight-count distribution according to some embodiments.

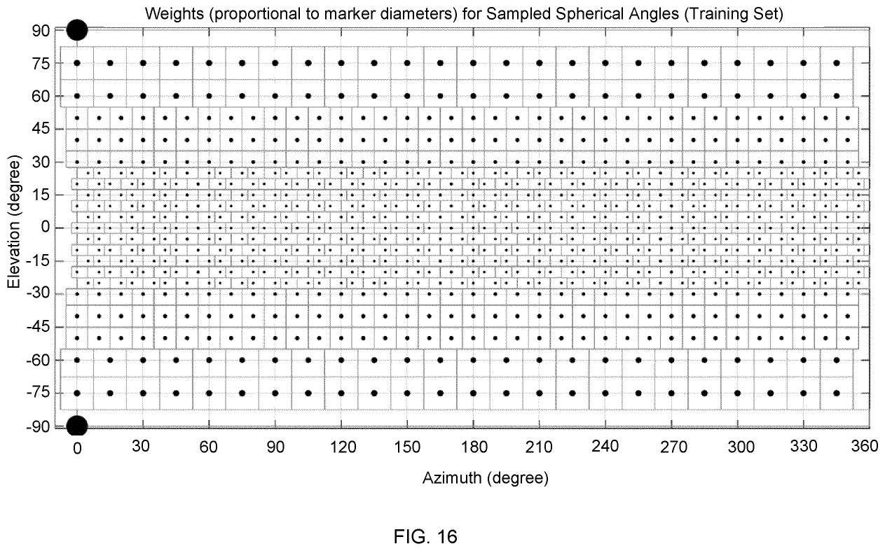

FIG. 16 shows the SP areas of the training set and a weight value variation that is determined based on the size of the SP areas. In FIG. 16, a dot included in each rectangle represents a weight value. The bigger the dot is, the higher the weight value is. As shown in FIG. 16, the bigger the SP area is the higher the weight value is.

As discussed above, in some embodiments, a weight value of each HR filter included in the training subset may be determined based on the size of the SP area of the HR filter, which is determined in step s802. However, in other embodiments, an updated SP area may be determined for each HR filter included in the training subset, and a weight value of an HR filter may be determined based on the updated SP area. In such embodiments, an optional step s805 may be performed. Step s805 comprises determining an updated SP area of a sample point associated with each HR filter included in the training subset. In step s802, the original SP area of a sample point associated with each HR filter can be determined based on distances between the HR filter and adjacent HR filter(s) that are adjacent to the HR filter in the initial set of HR filters. But in step s805, the updated SP area of a sample point associated with each HR filter can be determined based on distances between the HR filter and adjacent HR filter(s) that are adjacent to the HR filter in the training subset of HR filters. In a summary, in step s802, an SP area of a sample point of an HR filter is determined based on a relationship between the HR filter and other HR filters included in the initial set of HR filters while, in step s805, an SP area of a sample point of an HR filter is determined based on a relationship between the HR filter and other HR filters included in the training subset of HR filters.

After performing step s806, process 800 may proceed to step s808. Step s808 comprises using the weight values obtained in step s806 in generating an HR filter model.

Given that a training subset of HR filters is [symbol] _{T}={h₁, . . . , h_{N}_{_{T}}}, where each of h₁, h₂, . . . , h_{N}_{_{T}} is a K-dimensional HR filter vector indicating an ĥₙ filter at a certain elevation angle θₙ and a certain azimuth angle φₙ, a modeled HR filter ĥₙ that models each of h₁, h₂, . . . , h_{N}_{_{T}} may be determined as follows:

$${\hat{h}}_{n} = \hat{h} ( {θ}_{n} , {φ}_{n} , α ) = {\sum }_{p = 1}^{P} {\sum }_{q = 1}^{Q} {\sum }_{k = 1}^{K} {α}_{p , q , k} {Θ}_{p} ( {θ}_{n} ) {Φ}_{q} ( {φ}_{n} ) {e}_{k}$$

where {Θₚ:p=1, . . . , P} is a set of P basis functions over the elevation dimension, {φ_{q}:q=1, . . . , Q} is a set of Q basis functions over the azimuth dimension, {eₖ:k=1, . . . , K} is a set of K-dimensional basis vectors spanning the K-dimensional vector space, and α={α_{p,q,k}:p=1, . . . , P; q=1, . . . , Q; k=1, . . . , K} is a set of model parameters for forming an HR filter model.

The HR filter model (i.e., the set of optimal modeling parameters α of the HR filter model) may be obtained by minimizing the modeling error over the HR filters in the training-subset. Here, the modeling error indicates a difference between the measured HR filters and the modeled HR filters that model the measured HR filters. Thus, the closer the modeled HR filters are to the measured HR filters, the smaller the modelling error is, which means that the modeling of the HR filter model is good.

In some embodiments, the modeling error over the HR filters in the training subset of HR filters [symbol] _{T} may be calculated as a weighted modeling error as follows:

$${J}_{w} ( α ) = {\sum }_{n = 1}^{{N}_{T}} {w}_{n} μ ( {h}_{n} ( {θ}_{n} , {φ}_{n} ) - \hat{h} ( {θ}_{n} , {φ}_{n} , α ) )$$

where J_{w}(α) is the weighted modeling error of an HR filter set model having a set (α) of model parameters, N_{T} is a number of HR filters included in the training subset of HR filters, wₙ is weight value for an n-th HR filter in the training subset of HR filters, μ is a measure of a modeling error vector, hₙ(θₙ, φₙ) is an n-th HR filter in the training subset of HR filters, and ĥ(θₙ, φₙ, α) is a modeled HR filter modeling an n-th HR filter in the training subset of HR filters using the set (α) model parameters.

Often used u-measures are the p-norms for p=1 and p=2, where the p-norm of a K-dimensional vector x is given by:

$${‖ x ‖}_{p} = {( {\sum }_{k = 1}^{K} {\vert {x}_{k} \vert}^{p} )}^{1 / p}$$

Using the above equation for calculating the modeling error, the set (a) of model parameters that result in the minimum modeling error is determined, thereby determining an HR filter model.

In calculating the modeling error, by giving more weights to the differences between the measured HR filters and the modeled HR filters in regions with low sample point densities, i.e., as compared to the differences between the measured HR filters and the modeled HR filters in regions with high sample point densities, the set of model parameters that is geared towards more to reducing the differences between the measured HR filters and the modeled HR filters in regions with low sample point densities can be obtained. Thus, the resulting HR filter model would generate HR filters that model the measured HR filters more accurately in those regions with low sample point densities.

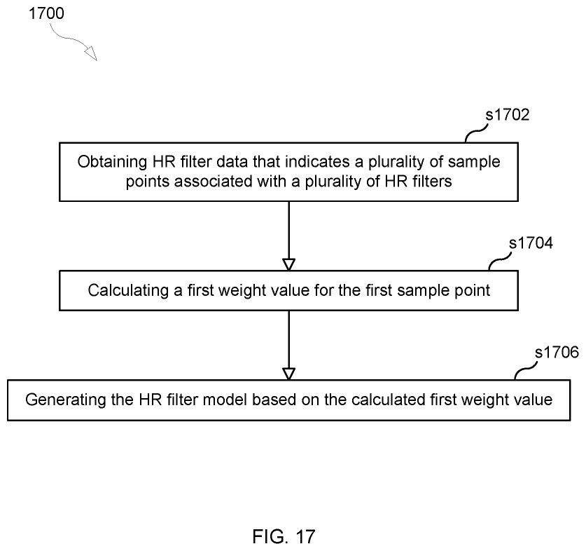

FIG. 17 shows a process 1700 for generating a head-related (HR) filter model for a set of HR filters, according to some embodiments. Process 1700 may begin with step s1702. Step s1702 comprises obtaining HR filter data that indicates a plurality of sample points associated with a plurality of HR filters, wherein the plurality of sample points includes a first sample point. The plurality of HR filters associated with the plurality of sample points indicated by the HR filter data is a subset of the set of HR filters. Step s1704 comprises calculating a first weight value for the first sample point, wherein the first weight value varies based on a density of sample points within an area encompassing the first sample point. Step s1706 comprises generating the HR filter model based on the calculated first weight value.

In some embodiments, the area encompassing the first sample point is an area of a virtual 2D sphere surrounding a listener or an area of an elevation-azimuth plane corresponding to an expansion of a surface of the virtual 2D sphere into a flat surface.

In some embodiments, process 1700 comprises calculating one or more distances between the first sample point and one or more sample points, wherein the first weight value is based on said one or more distances.

In some embodiments, process 1700 comprises determining a size of a first sample point area encompassing the first sample point, wherein the size of the first sample point area is based on said one or more distances, and the first weight value is based on the size of the first sample point area. The first sample point area is a portion of the area encompassing the first sample point, which was discussed in the step s1704.

In some embodiments, the first sample point area encompasses only the first sample point and does not encompass any other sample point.

In some embodiments, process 1700 comprises, for each sample point included in the plurality of sample points, determining a size of a sample point area encompassing the sample point; and for each sample point included in the plurality of sample points, calculating a weight value for the sample point based on the determined size of the sample point area encompassing the sample point, wherein the HR filter model is generated based on the calculated weight values.

In some embodiments, the size of the first sample point area encompassing the first sample point is determined based on one or more distances between the first sample point and one or more sample points that are adjacent to the first sample point.

In some embodiments, the size of the first sample point area encompassing the first sample point is determined based on: a distance between the first sample point and an adjacent sample point that is adjacent to the first sample point in a certain direction; and a preset value associated with 360 degrees or 2×π radians.

In some embodiments, the size of the first sample point area encompassing the first sample point is determined based on: a first distance between the first sample point and a first adjacent sample point that is adjacent to the first sample point in a first direction; a second distance between the first sample point and a second adjacent sample point that is adjacent to the first sample point in a second direction; a third distance between the first sample point and a third adjacent sample point that is adjacent to the first sample point in a third direction; and a fourth distance between the first sample point and a fourth adjacent sample point that is adjacent to the first sample point in a fourth direction.

In some embodiments, the first and second directions are opposite to each other, and the third and fourth directions are opposite to each other.

In some embodiments, a sample point is defined by an elevation angle and an azimuth angle, and the first sample point, the first adjacent sample point, and the second adjacent sample point have the same elevation angle but different azimuth angles.

In some embodiments, a sample point is defined by an elevation angle and an azimuth angle, and the first sample point, the third adjacent sample point, and the fourth adjacent sample point have different elevation angles.

In some embodiments, the first sample point, the third adjacent sample point, and the fourth adjacent sample point have different azimuth angles, the third distance between the first sample point and the third adjacent sample point is a difference between an elevation angle of the first sample point and an elevation angle of the third adjacent sample point, and the fourth distance between the first sample point and the fourth adjacent sample point is a difference between an elevation angle of the first sample point and an elevation angle of the fourth adjacent sample point.

In some embodiments, a shape of the first sample point area encompassing the first sample point is a polygon, and dimensions of the polygon are determined based on said one or more distances.

In some embodiments, a shape of the first sample point area encompassing the first sample point is a rectangle having a first dimension and a second dimension, the first dimension of the rectangle is determined based on ½ of the first distance and ½ of the second distance, and the second dimension of the rectangle is determined based on ½ of the third distance and ½ of the fourth distance.

In some embodiments, process 1700 comprises obtaining HR filter data indicating a set of sample points associated with the set of HR filters; and arranging sample points included in the set of sample points based on a size of a sample point area of each sample point included in the set of sample points, thereby obtaining an ordered list of sample points, wherein the plurality of sample points is selected from the ordered list of sample points.

In some embodiments, in the ordered list, the sample points are arranged in the order of decreasing a size of a sample point area encompassing a sample point, the plurality of sample points corresponds to first m number of sample points included in the ordered list or first pₘ % of sample points included in the ordered list, and m is a positive integer and/or pₘ is a positive real number.

In some embodiments, process 1700 comprises selecting a first group of sample points from the ordered list of sample points; and selecting a second group of sample points from the ordered list of sample points excluding the first group of sample points, wherein in the ordered list, the sample points are arranged in the order of decreasing size of sample point areas encompassing sample points, the first group of sample points corresponds to first m₁ number of sample points included in the ordered list or first pₘ, % of sample points included in the ordered list, the second group of sample points corresponds to m₂ number of sample points included in the ordered list excluding the first group of sample points or pₘ_{₂}% of sample points included in the ordered list excluding the first group of sample points, and the plurality of sample points includes the first group of sample points and the second group of sample points.

In some embodiments, the second group of sample points corresponds to: first m₂ number of sample points included in the ordered list excluding the first group of sample points or first pₘ_{₂}% of sample points included in the ordered list excluding the first group of sample points, or m₂ number of randomly selected sample points included in the ordered list excluding the first group of sample points or pₘ_{₂}% of randomly selected sample points included in the ordered list excluding the first group of sample points.

In some embodiments, the first weight value is calculated based on f(a₁, a_{T}) where a₁ corresponds the size of the first sample point area encompassing the first sample point and a_{T} corresponds to a size of an area encompassing the plurality of sample points.

In some embodiments

$$f ( {a}_{1} , {a}_{T} ) = {N}_{T} \times \frac{{a}_{1}}{{a}_{T}} ,$$

where N_{T} is a total number of sample points included in the plurality of sample points.

In some embodiments, the HR filter model is generated based on minimizing a modeling error over the plurality of sample points, and the modelling error is calculated based on the first weight value.

In some embodiments, the HR filter model is generated based on minimizing a modeling error over the plurality of sample points, and the modelling error is calculated based on the weight values.

In some embodiments,

$${J}_{w} ( α ) = {\sum }_{n = 1}^{{N}_{T}} {w}_{n} μ ( {h}_{n} ( {θ}_{n} , {φ}_{n} ) - \hat{h} ( {θ}_{n} , {φ}_{n} , α ) ) ,$$

where J_{w}(α) is the modelling error, α is a set of model parameters of the HR filter model, wₙ is a weight value associated with n-th sample point, N_{T} is a total number of the plurality of sample points, ĥ(θₙ, φₙ, α) is a modeled HR filter associated with an elevation angle θₙ, an azimuth angle φₙ, and the set of model parameters α, and hₙ is a measured HR filter associated with an elevation angle θₙ and an azimuth angle φₙ, and μ is a measure of a modeling error vector.

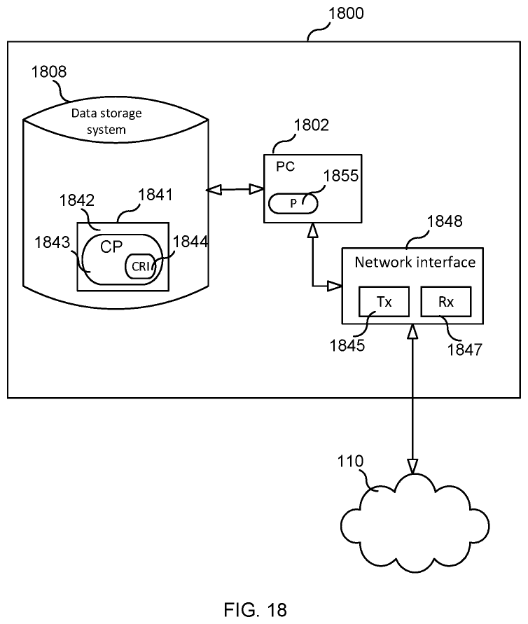

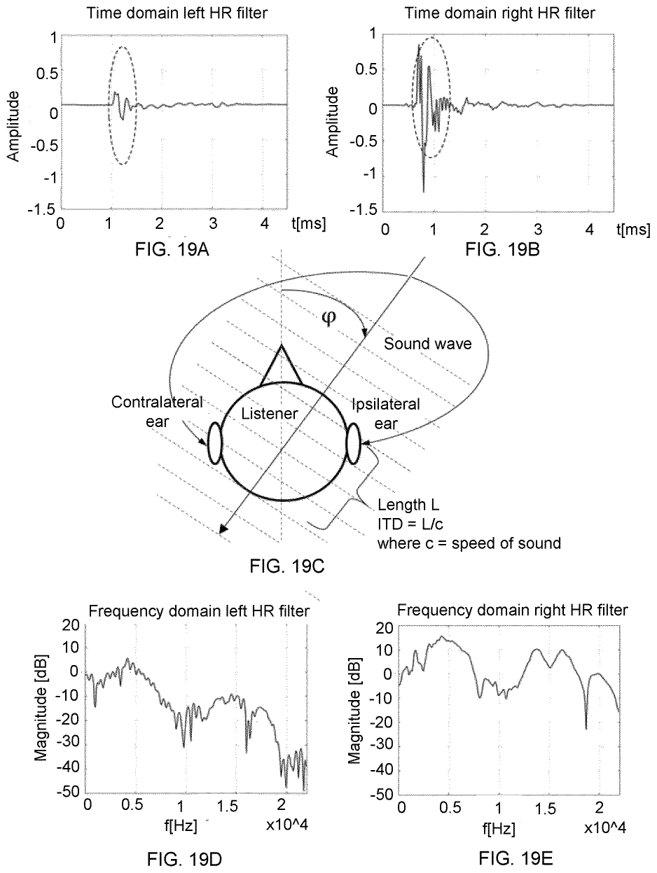

FIG. 18 is a block diagram of an apparatus 1800, according to some embodiments, for performing the methods described above for e.g., process 800 shown in FIG. 8 or process 900 shown in FIG. 9. As shown in FIG. 18, apparatus 1800 may comprise: processing circuitry (PC) 1802, which may include one or more processors (P) 1855 (e.g., a general purpose microprocessor and/or one or more other processors, such as an application specific integrated circuit (ASIC), field-programmable gate arrays (FPGAs), and the like), which processors may be co-located in a single housing or in a single data center or may be geographically distributed (i.e., apparatus 1800 may be a distributed computing apparatus); at least one network interface 1848, each network interface 1848 comprises a transmitter (Tx) 1845 and a receiver (Rx) 1847 for enabling apparatus 1800 to transmit data to and receive data from other nodes connected to a network 110 (e.g., an Internet Protocol (IP) network) to which network interface 1848 is connected directly or indirectly for e.g., network interface 1848 may be wirelessly connected to the network 110, in which case network interface 1848 is connected to an antenna arrangement; and one or more storage units a.k.a., “data storage system” 1808, which may include one or more non-volatile storage devices and/or one or more volatile storage devices. In embodiments where PC 1802 includes a programmable processor, a computer program product (CPP) 1841 may be provided. CPP 1841 includes a computer readable medium (CRM) 1842 storing a computer program (CP) 1843 comprising computer readable instructions (CRI) 1844. CRM 1842 may be a non-transitory computer readable medium, such as, magnetic media for e.g., a hard disk, optical media, memory devices for e.g., random access memory, flash memory, and the like. In some embodiments, the CRI 1844 of computer program 1843 is configured such that when executed by PC 1802, the CRI causes apparatus 1800 to perform steps described herein for e.g., steps described herein with reference to the flow charts. In other embodiments, apparatus 1800 may be configured to perform steps described herein without the need for code. That is, for example, PC 1802 may consist merely of one or more ASICs. Hence, the features of the embodiments described herein may be implemented in hardware and/or software.

### Summary of Embodiments

A1. A method (1700) for generating a head-related, HR, filter model for a set of HR filters, the method comprising:
obtaining (s1702) HR filter data that indicates a plurality of sample points associated with a plurality of HR filters, wherein the plurality of sample points includes a first sample point;
calculating (s1704) a first weight value for the first sample point, wherein the first weight value varies based on a density of sample points within an area encompassing the first sample point; and generating (s1706) the HR filter model based on the calculated first weight value.
A1a. The method of embodiment A1, wherein the area is an area of a virtual 2D sphere surrounding a listener or an area of an elevation-azimuth plane corresponding to an expansion of a surface of the virtual 2D sphere into a flat surface.
A2. The method of embodiment A1 or A1a, the method comprising:
calculating one or more distances between the first sample point and one or more sample points, wherein
the first weight value is based on said one or more distances.
A3. The method of embodiment A2, the method comprising:
determining a size of a first sample point area encompassing the first sample point, wherein
the size of the first sample point area is based on said one or more distances, and
the first weight value is based on the size of the first sample point area.
A4. The method of embodiment A3, wherein the first sample point area encompasses only the first sample point and does not encompass any other sample point.
A5. The method of embodiment A4, the method comprising:
for each sample point included in the plurality of sample points, determining a size of a sample point area encompassing each sample point; and
for each sample point included in the plurality of sample points, calculating a weight value for each sample point based on the determined size of the sample point area encompassing each sample point, wherein
the HR filter model is generated based on the calculated weight values.
A6. The method of any one of embodiments A3-A5, wherein the size of the first sample point area encompassing the first sample point is determined based on two or more distances between the first sample point and two or more sample points that are adjacent to the first sample point.
A7. The method of embodiment A6, wherein the size of the first sample point area encompassing the first sample point is determined based on:
a first distance between the first sample point and a first adjacent sample point that is adjacent to the first sample point in a first direction;
a second distance between the first sample point and a second adjacent sample point that is adjacent to the first sample point in a second direction;
a third distance between the first sample point and a third adjacent sample point that is adjacent to the first sample point in a third direction; and
a fourth distance between the first sample point and a fourth adjacent sample point that is adjacent to the first sample point in a fourth direction.
A8. The method of embodiment A7, wherein
the first and second directions are opposite to each other, and
the third and fourth directions are opposite to each other.
A9. The method of embodiment A7 or A8, wherein a sample point is defined by an elevation angle and an azimuth angle, and
the first sample point, the first adjacent sample point, and the second adjacent sample point have the same elevation angle but different azimuth angles.
A10. The method of any one of embodiments A7-A9, wherein
a sample point is defined by an elevation angle and an azimuth angle, and
the first sample point, the third adjacent sample point, and the fourth adjacent sample point have different elevation angles.
A11. The method of embodiment A10, wherein
the first sample point, the third adjacent sample point, and the fourth adjacent sample point have different azimuth angles,
the third distance between the first sample point and the third adjacent sample point is a difference between an elevation angle of the first sample point and an elevation angle of the third adjacent sample point, and
the fourth distance between the first sample point and the fourth adjacent sample point is a difference between an elevation angle of the first sample point and an elevation angle of the fourth adjacent sample point.
A12. The method of any one of embodiments A3-A11, wherein
a shape of the first sample point area encompassing the first sample point is a polygon, and
dimensions of the polygon are determined based on said one or more distances.
A13. The method of any one of embodiments A7-A12, wherein
a shape of the first sample point area encompassing the first sample point is a rectangle having a first dimension and a second dimension,
the first dimension of the rectangle is determined based on ½ of the first distance and ½ of the second distance, and
the second dimension of the rectangle is determined based on ½ of the third distance and ½ of the fourth distance.
A13a. The method of any one of embodiments A1-A13, the method comprising:
obtaining HR filter data indicating a set of sample points associated with the set of HR filters; and
arranging sample points included in the set of sample points based on a size of an SP area of each sample point included in the set of sample points, thereby obtaining an ordered list of sample points, wherein
the plurality of sample points is selected from the ordered list of sample points.
A14. The method of embodiment A13a, wherein
in the ordered list, the sample points are arranged in the order of decreasing a size of a sample point area encompassing a sample point,
the plurality of sample points corresponds to first m number of sample points included in the ordered list or first pₘ % of sample points included in the ordered list, and
m is a positive integer and/or pₘ is a positive real number.
A14a. The method of embodiment A13a, the method comprising:
selecting a first group of sample points from an ordered list of sample points; and
selecting a second group of sample points from the ordered list of sample points excluding the first group of sample points, wherein
in the ordered list, the sample points are arranged in the order of decreasing size of sample point areas encompassing sample points,
the first group of sample points corresponds to first m₁ number of sample points included in the ordered list or first pₘ, % of sample points included in the ordered list,
the second group of sample points corresponds to m₂ number of sample points included in the ordered list excluding the first group of sample points or pₘ_{₂}% of sample points included in the ordered list excluding the first group of sample points, and
the plurality of sample points includes the first group of sample points and the second group of sample points.
A14b. The method of embodiment A14a, wherein the second group of sample points corresponds to:
first m₂ number of sample points included in the ordered list or first pₘ_{₂}% of sample points included in the ordered list excluding the first group of sample points, or
m₂ number of randomly selected sample points included in the ordered list excluding the first group of sample points or pₘ_{₂}% of randomly selected sample points included in the ordered list excluding the first group of sample points.
A15. The method of any one of embodiments A3-A14b, wherein the first weight value is calculated based on f(a₁, a_{T}) where a₁ corresponds the size of the first sample point area encompassing the first sample point and a_{T} corresponds to a size of an area encompassing the plurality of sample points.
A16. The method of embodiment A15, wherein

$$f ( {a}_{1} , {a}_{T} ) = {N}_{T} \times \frac{{a}_{1}}{{a}_{T}} ,$$

where N_{T} is a total number of sample points included in the plurality of sample points.
A17. The method of any one of embodiments A1-A16, wherein
the HR filter model is generated based on minimizing a modeling error over the plurality of sample points, and
the modelling error is calculated based on the first weight value.
A18. The method of any one of embodiments A5-A16, wherein
the HR filter model is generated based on minimizing a modeling error over the plurality of sample points, and
the modelling error is calculated based on the weight values.
A19. The method of embodiment A18, wherein

$${J}_{w} ( α ) = {\sum }_{n = 1}^{{N}_{T}} {w}_{n} μ ( {h}_{n} ( {θ}_{n} , {φ}_{n} ) - \hat{h} ( {θ}_{n} , {φ}_{n} , α ) ) ,$$

where
J_{w}(α) is the modelling error,
α is a set of model parameters of the HR filter model,
wₙ is a weight value associated with n-th sample point,
N_{T} is a total number of the plurality of sample points,
ĥ(θₙ, φₙ, α) is a modeled HR filter associated with an elevation angle θₙ, an azimuth angle φₙ, and the set of model parameters α, and
hₙ is a measured HR filter associated with an elevation angle θₙ and an azimuth angle φₙ, and
μ is a measure of a modeling error vector.
B1. A computer program (1800) comprising instructions (1844) which when executed by processing circuitry (1802) cause the processing circuitry to perform the method of any one of embodiments A1-A19.
B2. A carrier containing the computer program of embodiment B1, wherein the carrier is one of an electronic signal, an optical signal, a radio signal, and a computer readable storage medium.
C1. An apparatus (1800) for generating a head-related, HR, filter model for a set of HR filters, the apparatus being configured to:
obtain (s1702) HR filter data that indicates a plurality of sample points associated with a plurality of HR filters, wherein the plurality of sample points includes a first sample point;
calculate (s1704) a first weight value for the first sample point, wherein the first weight value varies based on a density of sample points within an area encompassing the first sample point; and
generate (s1706) the HR filter model based on the calculated first weight value.
C2. The apparatus of embodiment C1, wherein the apparatus is configured to perform the method of at least one of embodiments A2-A19.
D1. An apparatus (1800) comprising:
a processing circuitry (1802); and
a memory (1841), said memory containing instructions executable by said processing circuitry, whereby the apparatus is operative to perform the method of at least one of embodiments A1-A19.

### CONCLUSION

While various embodiments are described herein, it should be understood that they have been presented by way of example only, and not limitation. Thus, the breadth and scope of this disclosure should not be limited by any of the above described exemplary embodiments. Moreover, any combination of the above-described elements in all possible variations thereof is encompassed by the disclosure unless otherwise indicated herein or otherwise clearly contradicted by context.

Additionally, while the processes described above and illustrated in the drawings are shown as a sequence of steps, this was done solely for the sake of illustration. Accordingly, it is contemplated that some steps may be added, some steps may be omitted, the order of the steps may be re-arranged, and some steps may be performed in parallel.

1. A method for generating a head-related, HR, filter model for a set of HR filters, the method comprising:
obtaining HR filter data that indicates a plurality of sample points associated with a plurality of HR filters, wherein the plurality of sample points includes a first sample point;
calculating a first weight value for the first sample point, wherein the first weight value varies based on a density of sample points within an area encompassing the first sample point; and
generating the HR filter model based on the calculated first weight value.

2. The method of claim 1, wherein the area encompassing the first sample point is an area of a virtual 2D sphere surrounding a listener or an area of an elevation-azimuth plane corresponding to an expansion of a surface of the virtual 2D sphere into a flat surface.

3. The method of claim 1: wherein
the method further comprises calculating one or more distances between the first sample point and one or more sample points, and
the first weight value is based on said one or more distances.

4. The method of claim 3, wherein
the method further comprises determining a size of a first sample point area encompassing the first sample point,
the size of the first sample point area is based on said one or more distances, and
the first weight value is based on the size of the first sample point area.

5. The method of claim 4, wherein the first sample point area encompasses the first sample point and does not encompass any other sample point.

6. The method of claim 5, wherein
the method further comprises, for each sample point included in the plurality of sample points, determining a size of a sample point area encompassing the sample point,
the method further comprises, for each sample point included in the plurality of sample points, calculating a weight value for the sample point based on the determined size of the sample point area encompassing the sample point, and
the HR filter model is generated based on the calculated weight values.

7. The method of of claim 4, wherein the size of the first sample point area encompassing the first sample point is determined based on one or more distances between the first sample point and one or more sample points that are adjacent to the first sample point.

8. The method of claim 7, wherein the size of the first sample point area encompassing the first sample point is determined based on:
a distance between the first sample point and an adjacent sample point that is adjacent to the first sample point in a certain direction, and
a preset value associated with 360 degrees or 2×π It radians.

9. The method of claim 7, wherein the size of the first sample point area encompassing the first sample point is determined based on:
a first distance between the first sample point and a first adjacent sample point that is adjacent to the first sample point in a first direction;
a second distance between the first sample point and a second adjacent sample point that is adjacent to the first sample point in a second direction;
a third distance between the first sample point and a third adjacent sample point that is adjacent to the first sample point in a third direction; and
a fourth distance between the first sample point and a fourth adjacent sample point that is adjacent to the first sample point in a fourth direction.

10. The method of claim 9, wherein
the first and second directions are opposite to each other, and
the third and fourth directions are opposite to each other.

11. The method of claim 9, wherein
each of the first sample point, the first adjacent sample point, and the second adjacent sample point is defined by an elevation angle and an azimuth angle, and
the first sample point, the first adjacent sample point, and the second adjacent sample point have the same elevation angle but different azimuth angles.

12. The method of claim 9, wherein
each of the third adjacent sample point and the fourth adjacent sample point is defined by an elevation angle and an azimuth angle, and
the first sample point, the third adjacent sample point, and the fourth adjacent sample point have different elevation angles.

13. The method of claim 12, wherein
the first sample point, the third adjacent sample point, and the fourth adjacent sample point have different azimuth angles,
the third distance between the first sample point and the third adjacent sample point is a difference between an elevation angle of the first sample point and an elevation angle of the third adjacent sample point, and
the fourth distance between the first sample point and the fourth adjacent sample point is a difference between an elevation angle of the first sample point and an elevation angle of the fourth adjacent sample point.

14. The method of claim 4, wherein
a shape of the first sample point area encompassing the first sample point is a polygon, and
dimensions of the polygon are determined based on said one or more distances.

15. The method of claim 9, wherein
a shape of the first sample point area encompassing the first sample point is a rectangle having a first dimension and a second dimension,
the first dimension of the rectangle is determined based on ½ of the first distance and ½ of the second distance, and
the second dimension of the rectangle is determined based on ½ of the third distance and ½ of the fourth distance.

16. The method of claim 1, the method comprising: wherein
the method further comprises obtaining HR filter data indicating a set of sample points associated with the set of HR filters,
the method further comprises arranging sample points included in the set of sample points based on a size of a sample point area of each sample point included in the set of sample points, thereby obtaining an ordered list of sample points, and
the plurality of sample points is selected from the ordered list of sample points.

17. The method of claim 16, wherein
in the ordered list, the sample points are arranged in the order of decreasing a size of a sample point area encompassing a sample point,
the plurality of sample points corresponds to first m number of sample points included in the ordered list or first pₘ % of sample points included in the ordered list, and
m is a positive integer and/or pₘ is a positive real number.

18. The method of claim 16, wherein
the method further comprises selecting a first group of sample points from the ordered list of sample points,
the method further comprises selecting a second group of sample points from the ordered list of sample points excluding the first group of sample points,
in the ordered list, the sample points are arranged in the order of decreasing size of sample point areas encompassing sample points,
the first group of sample points corresponds to first m₁ number of sample points included in the ordered list or first pₘ_{₂}% of sample points included in the ordered list,
the second group of sample points corresponds to m₂ number of sample points included in the ordered list excluding the first group of sample points or pₘ_{₂} % of sample points included in the ordered list excluding the first group of sample points, and
the plurality of sample points includes the first group of sample points and the second group of sample points.

19. The method of claim 18, wherein the second group of sample points corresponds to:
first m₂ number of sample points included in the ordered list excluding the first group of sample points or first pₘ_{₂} % of sample points included in the ordered list excluding the first group of sample points, or
m₂ number of randomly selected sample points included in the ordered list excluding the first group of sample points or pₘ_{₂} % of randomly selected sample points included in the ordered list excluding the first group of sample points.

20. (canceled)

21. The method of claim 4, wherein
the first weight value is calculated based on f(a₁, a_{T}) where a₁ corresponds the size of the first sample point area encompassing the first sample point and a_{T} corresponds to a size of an area encompassing the plurality of sample points, and
$$f ( {a}_{1} , {a}_{T} ) = {N}_{T} \times \frac{{a}_{1}}{{a}_{T}} ,$$
where N_{T} is a total number of sample points included in the plurality of sample points.

22. The method of claim 1, wherein
the HR filter model is generated based on minimizing a modeling error over the plurality of sample points, and
the modelling error is calculated based on the first weight value.

23. The method of claim 6, wherein
the HR filter model is generated based on minimizing a modeling error over the plurality of sample points, and
the modelling error is calculated based on the weight values.

24. The method of claim 23, wherein
$${J}_{w} ( α ) = {\sum }_{n = 1}^{{N}_{T}} {w}_{n} μ ( {h}_{n} ( {θ}_{n} , {φ}_{n} ) - \hat{h} ( {θ}_{n} , {φ}_{n} , α ) ) ,$$
where
J_{w}(α) is the modelling error,
α is a set of model parameters of the HR filter model,
wₙ is a weight value associated with n-th sample point,
N_{T} is a total number of the plurality of sample points,
\tilde{h}(θₙ, φₙ, α) is a modeled HR filter associated with an elevation angle θₙ, an azimuth angle φₙ, and the set of model parameters α, and
hₙ is a measured HR filter associated with an elevation angle θₙ and an azimuth angle φₙ, and
μ is a measure of a modeling error vector.

25-26. (canceled)

27. An apparatus for generating a head-related, HR, filter model for a set of HR filters, the apparatus comprising:
memory; and
processing circuitry, wherein the apparatus is configured to:
obtain HR filter data that indicates a plurality of sample points associated with a plurality of HR filters, wherein the plurality of sample points includes a first sample point;
calculate a first weight value for the first sample point, wherein the first weight value varies based on a density of sample points within an area encompassing the first sample point; and
generate the HR filter model based on the calculated first weight value.

28-29. (canceled)
